(19) United States
(12) Patent Application Publication
(10) Pub. No.: US 2024/0397003 A1
(43) Pub. Date: Nov. 28, 2024

(54) INFORMATION PROCESSING SYSTEM AND INFORMATION PROCESSING METHOD

(71) Applicant: KYOCERA Document Solutions Inc., Osaka (JP)

(72) Inventors: Masato Hirabe, Osaka (JP); Kohei Konishi, Osaka (JP); Yoshifumi Okabayashi, Osaka (JP); Daigo Tashiro, Osaka (JP)

(21) Appl. No.: 18/671,778

(22) Filed: May 22, 2024

(30) Foreign Application Priority Data
May 23, 2023 (JP) 2023-084354

(51) Int. Cl. H04N 1/00; G06F 16/248

(52) U.S. Cl. CPC H04N 1/00427; G06F 16/248; H04N 1/00411; H04N 1/00474; H04N 2201/0094

(57) ABSTRACT

An information processing system includes a display processing portion, a reception processing portion, and a control processing portion. The display processing portion displays a first screen for receiving remote operation of an image forming apparatus and a second screen for operation of the image forming apparatus in one display area of an operation terminal. The reception processing portion receives user operations on each of the first screen and the second screen. When the reception processing portion receives the user operation on one of the first screen and the second screen, the control processing portion changes display content on the other screen to content corresponding to the user operation.

### INCORPORATION BY REFERENCE

This application is based upon and claims the benefit of priority from the corresponding Japanese Patent Application No. 2023-084354 filed on May 23, 2023, the entire content of which are incorporated herein by reference.

### BACKGROUND

The present disclosure relates to an information processing system and an information processing method.

A technique is known in which an operation screen (setting screen) and an operation manual screen are displayed side by side on one screen in a display portion of an image forming apparatus.

### SUMMARY

An information processing system according to one aspect of the present disclosure includes a display processing portion, a reception processing portion, and a control processing portion. The display processing portion displays a first screen for receiving remote operation of an image forming apparatus and a second screen for operation of the image forming apparatus in one display area of an operation terminal. The reception processing portion receives user operations on each of the first screen and the second screen. When the reception processing portion receives the user operation on one of the first screen and the second screen, the control processing portion changes display content on the other screen to content corresponding to the user operation.

An information processing method according to another aspect of the present disclosure includes a display step, a reception step, and a change step. In the display step, a first screen for receiving remote operation of an image forming apparatus and a second screen for operation of the image forming apparatus are displayed in one display area of an operation terminal. In the reception step, user operations on each of the first screen and the second screen are received. In the control step, display content on one screen of the first screen and the second screen are changed to content corresponding to the user operation when the user operation is received on the other screen.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing a configuration of an information processing system of an embodiment according to the present disclosure.

FIG. 2 is a block diagram showing a configuration of an information processing system of an embodiment according to the present disclosure.

FIG. 3 is a diagram showing an example of a settings screen displayed on an image forming apparatus according of an embodiment according to the present disclosure.

FIG. 4 is a diagram showing an example of an operation manual screen displayed on an image forming apparatus of an embodiment according to the present disclosure.

FIG. 5 is a diagram showing an example of a setting screen displayed on an operation terminal of an embodiment according to the present disclosure.

FIG. 6 is a diagram showing an example of an operation manual screen displayed on an operation terminal of an embodiment according to the present disclosure.

FIG. 7 is a diagram showing an example of a setting screen and an operation manual screen displayed on an operation terminal of an embodiment according to the present disclosure.

FIG. 8 is a diagram showing an example of a setting screen and an operation manual screen displayed on an operation terminal of an embodiment according to the present disclosure.

FIG. 9 is a diagram showing an example of a setting screen and an operation manual screen displayed on an operation terminal of an embodiment according to the present disclosure.

FIG. 10 is a flowchart showing an example of a procedure of an information notification process executed by an information processing system of an embodiment according to the present disclosure.

### DETAILED DESCRIPTION

Embodiments according to the present disclosure will be described below with reference to the accompanying drawings to provide an understanding of the technique according to the present disclosure. Note that the following embodiments are examples that embody the technique according to the present disclosure, and do not limit the technical scope of the present disclosure.

### [Information Processing System 10]

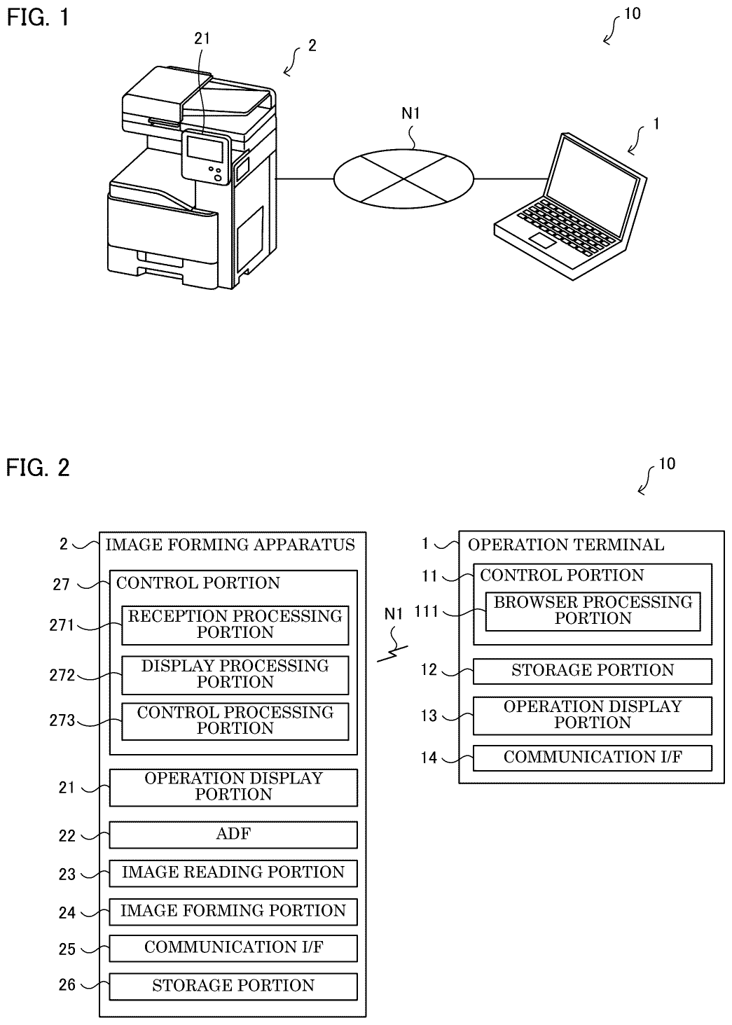

As shown in FIG. 1, an information processing system 10 of an embodiment according to the present disclosure includes an operation terminal 1 and an image forming apparatus 2. The information processing system 10 is an example of an information processing system according to the present disclosure, the image forming apparatus 2 is an example of an image forming apparatus according to the present disclosure, and the operation terminal 1 is an example of an operation terminal according to the present disclosure. The operation terminal 1 is an information processing apparatus such as a notebook computer, a mobile terminal, or a smartphone, and is an example of a user terminal. The image forming apparatus 2 and the operation terminal 1 are able to communicate via a network N1 such as a telephone line, the Internet, or a LAN.

In the information processing system 10, for example, when a user operates the operation terminal 1 to perform a remote operation (printing instruction) to submit a desired printing job, the image forming apparatus 2 acquires and executes the printing job (printing process). In addition, when the user performs an operation to scan a document using the image forming apparatus 2, image data obtained by reading an image from the document is transmitted to the operation terminal 1 (scanning process). The user can display an operation screen (remote panel connection screen) on the operation terminal 1 and perform setting operations (execution instructions) for various types of jobs to be executed by the image forming apparatus 2. In addition, the user is able to display an operation manual screen on the operation terminal 1 and check the operation manual of the image forming apparatus 2. Note that the operation screen and the operation manual screen may also be displayed on the operation display portion 21 of the image forming apparatus 2. In this way, the user is able to display the screen displayed on the image forming apparatus 2 on the operation terminal 1 at a location separated from the image forming apparatus 2 and perform remote operation.

In a known technique, the operation screen and the operation manual screen are displayed separately, and thus the user needs to operate the operation manual screen separately, for example, when investigating how to operate the settings on the setting screen. Therefore, even though there is an advantage of being able to check the operation screen and the operation manual screen on one screen, there is a problem in that doing so is not convenient. In contrast, in the information processing system 10 according to the present embodiment, as will be shown below, a plurality of screens related to the operation of the image forming apparatus 2 are displayed in one display area of the operation terminal 1, and it is possible to improve the convenience of operations on multiple screens.

### [Image Forming Apparatus 2]

As shown in FIG. 2, the image forming apparatus 2 includes an operation display portion 21, an auto document feeder (ADF) 22, an image reading portion 23, an image forming portion 24, a communication I/F 25, a storage portion 26, a control portion 27, and the like. More specifically, the image forming apparatus 2 is a multifunction peripheral having a printer function, a scanner function, a copy function, a facsimile function, and the like. Note that the image forming apparatus according to the present disclosure is applicable not only to multifunction peripherals but also to any image forming apparatus such as a copy machine, a printer, and a facsimile apparatus.

The operation display portion 21 includes a display portion such as a liquid crystal display that displays information, and an operation portion such as a touch panel and operation buttons that receive user operations.

The ADF 22 is an automatic document feeding device that includes a document setting portion, a conveying roller, a document holder, and a sheet discharge portion, and conveys a document to be read by the image reading portion 23.

The image reading portion 23 includes a document table, a light source, a mirror, an optical lens, and a charge coupled device (CCD), and is capable of reading an image of a document and outputting the result as image data.

The image forming portion 24 is capable of executing a printing process based on image data using an electrophotographic method or an inkjet method, and forms an image on a sheet based on the image data. For example, in a case where the image forming portion 24 is an electrophotographic image forming portion, the image forming portion 24 includes a photoconductor drum, a charging device, an exposure device, a developing device, a transfer device, a fixing device, and the like.

The communication I/F 25 is a communication interface that is capable of executing wired or wireless data communication with an external device. For example, the communication I/F 25 performs data communication with the operation terminal 1 via a network N1.

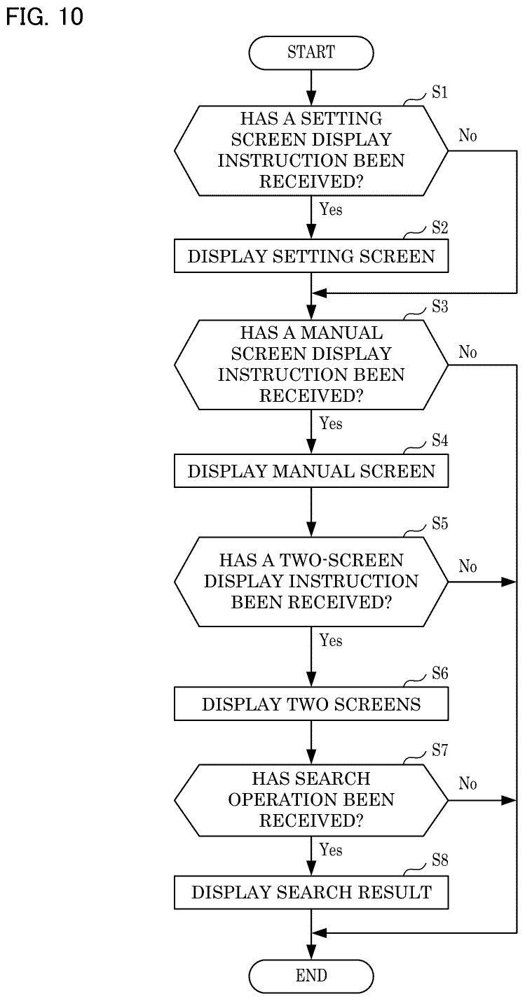

The storage portion 26 is a non-volatile storage portion such as a flash memory, a hard disk, or an EEPROM (registered trademark). The storage portion 26 stores various types of control programs executed by the control portion 27, various types of data, and the like. A control program executed by the control portion 27 includes a display control program for causing the control portion 27 to execute a display control process (see FIG. 10), which will be described later.

The control portion 27 includes control devices such as a CPU, ROM, and RAM. The CPU is a processor that executes various types of arithmetic processing. The ROM is a non-volatile storage portion in which information such as control programs for causing the CPU to execute various types of processes is stored in advance. The RAM is a volatile or non-volatile storage portion used as a temporary storage memory (work area) for various types of processes executed by the CPU.

More specifically, the control portion 27 includes a reception processing portion 271, a display processing portion 272, a control processing portion 273, and the like. Note that the control portion 27 functions as each of these processing portions by executing various types of processes according to the control program. In addition, the control portion 27 may include an electronic circuit that achieves some or a plurality of processing functions of each of these processing portions.

The reception processing portion 271 receives various types of operations from the user. The display processing portion 272 causes the operation display portion 21 of the image forming apparatus 2 to display various types of information.

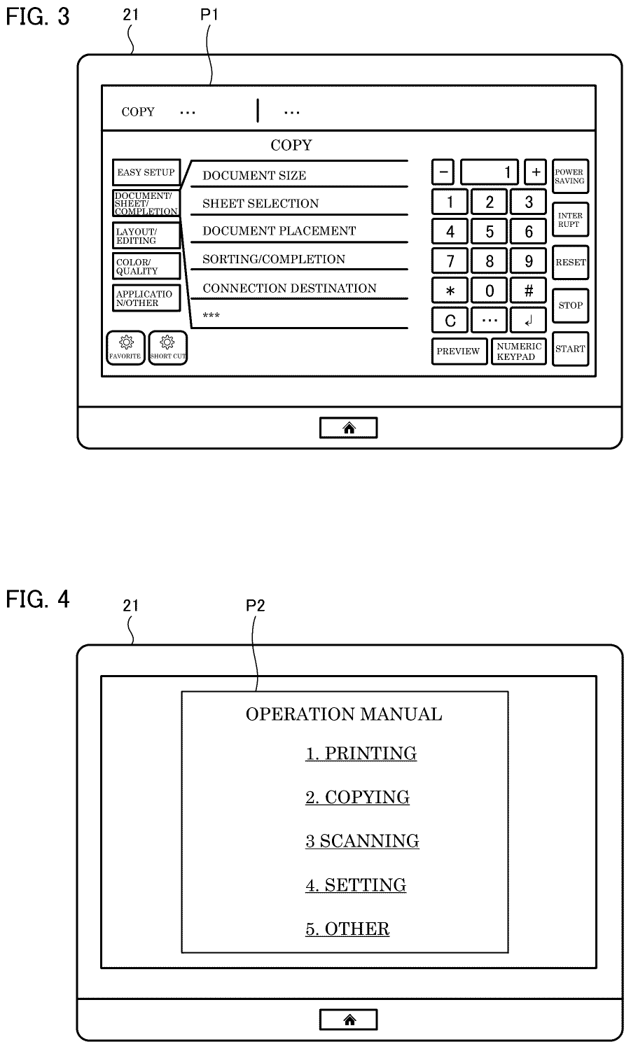

For example, the display processing portion 272 causes the operation display portion 21 to display a setting screen P1 that receives setting operations (for example, job setting operations) for the image forming apparatus 2. FIG. 3 shows an example of the setting screen P1. In a case where the user performs a setting operation on the setting screen P1, the reception processing portion 271 receives the setting operation. The control portion 27 executes processing (printing process, scanning process, etc.) according to the setting operation received by the reception processing portion 271.

In addition, the display processing portion 272, for example, causes the operation display portion 21 of the image forming apparatus 2 to display the operation manual screen P2. FIG. 4 shows an example of the operation manual screen P2. In a case where the user performs a selection operation on the operation manual screen P2, the reception processing portion 271 receives the selection operation. The display processing portion 272 causes the operation display portion 21 to display the operation manual (corresponding page) for the item selected by the user.

Moreover, the reception processing portion 271 is able to receive a remote operation from a user via the operation terminal 1. Furthermore, the display processing portion 272 is able to cause the operation terminal 1 to display various types of information. For example, the display processing portion 272 displays on the operation display portion 13 of the operation terminal 1 a login screen (not shown) for using the image forming apparatus 2, a setting screen P1 for performing setting operations for the image forming apparatus 2, an operation manual screen P2, and the like. The reception processing portion 271 receives, from the user, an operation to input login information (user ID, password, etc.) on the login screen, a setting operation (execution instruction) on the setting screen P1, a selection operation on the operation manual screen P2, and the like.

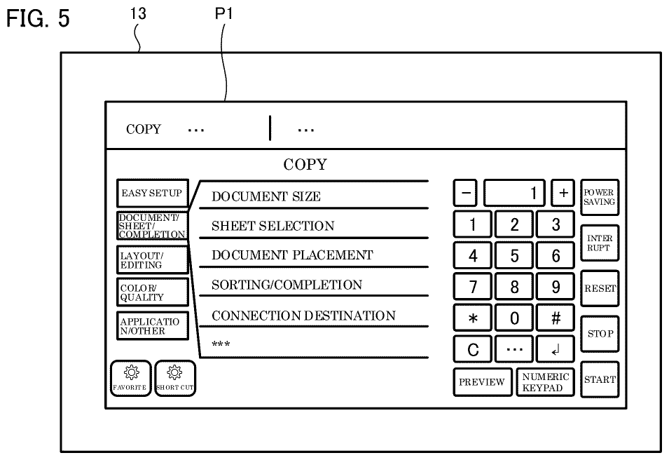

FIG. 5 shows an example of the setting screen P1 displayed on the operation display portion 13 of the operation terminal 1. The content of the setting screen P1 (see FIG. 5) displayed on the operation terminal 1 and the content of the setting screen P1 (see FIG. 3) displayed on the image forming apparatus 2 are the same. Note that the content of the setting screen P1 displayed on the operation terminal 1 and the content of the setting screen P1 displayed on the image forming apparatus 2 may be different. For example, on the setting screen P1 displayed on the operation terminal 1, content that does not allow remote operation of the image forming apparatus 2 may be omitted.

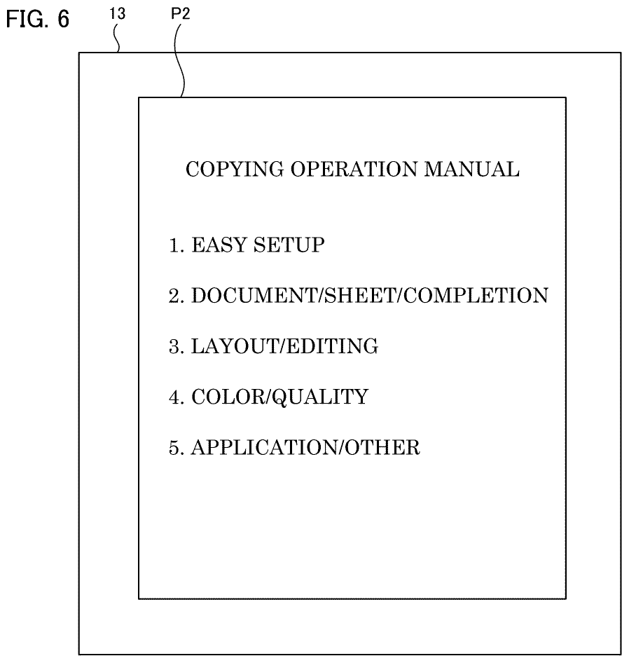

FIG. 6 shows an example of an operation manual screen P2 displayed on the operation display portion 13 of the operation terminal 1. Content of the operation manual screen P2 (see FIG. 6) displayed on the operation terminal 1 and content of the operation manual screen P2 (see FIG. 4) displayed on the image forming apparatus 2 are the same. Note that the content of the operation manual screen P2 displayed on the operation terminal 1 and the content of the operation manual screen P2 displayed on the image forming apparatus 2 may be different. For example, on the operation manual screen P2 displayed on the operation terminal 1, content that does not allow remote operation of the image forming apparatus 2 may be omitted.

As described above, the display processing portion 272 is able to display the setting screen P1 and the operation manual screen P2 on each the image forming apparatus 2 and the operation terminal 1. In addition, the reception processing portion 271 is able to receive various type of operations from users on each the image forming apparatus 2 and the operation terminal 1. Thus, remote operation (remote control) of the image forming apparatus 2 becomes possible. As another embodiment, the setting screen P1 and the operation manual screen P2 may be stored on a server connected to the image forming apparatus 2 via the network N1. In this case, the server may display the setting screen P1 and the operation manual screen P2 on each the image forming apparatus 2 and the operation terminal 1, respectively.

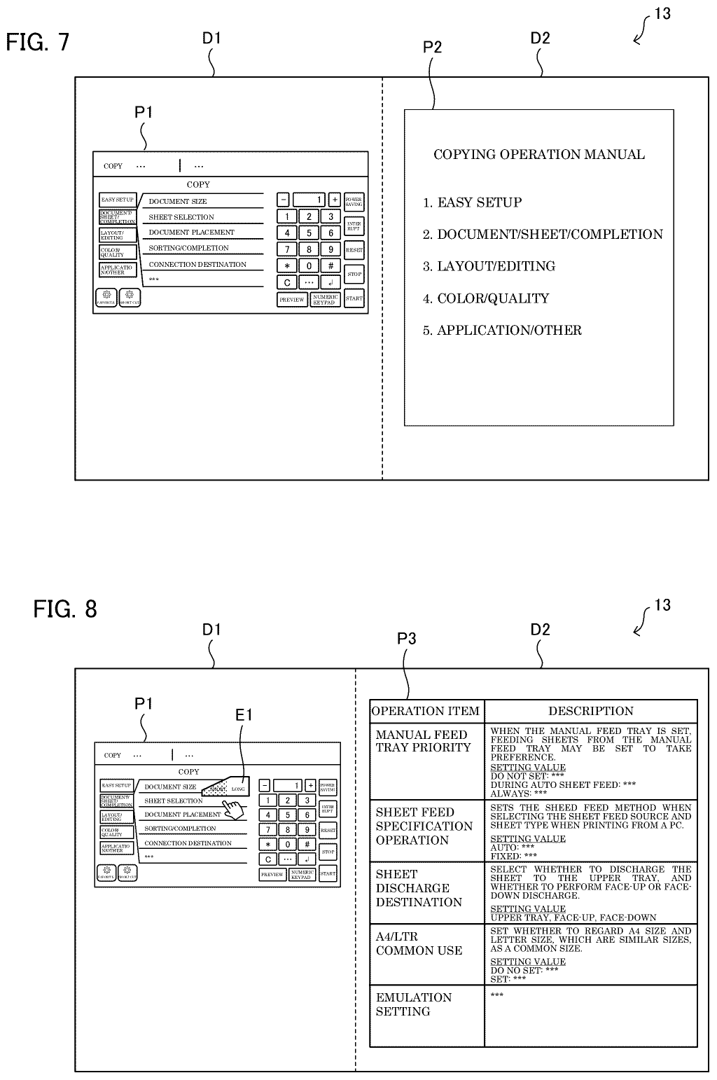

Moreover, the display processing portion 272 is able to display the setting screen P1 and the operation manual screen P2 together in one display area on the operation terminal 1. The display processing portion 272 divides one display area into a plurality of divided areas on the operation display portion 13 of the operation terminal 1, and displays a screen in each divided area. For example, as shown in FIG. 7, the display processing portion 272 divides one display area into a left side area D1 and a right side area D2, displays the setting screen P1 (first screen according to the present disclosure) in the left side area D1, and displays the operation manual screen P2 (second screen according to the present disclosure) in the right area D2. Note that the method of dividing the display area and the size of each divided area are not limited.

For example, when the user performs a predetermined operation (screen dividing operation) on the setting screen P1 (see FIG. 5) or the operation manual screen P2 (see FIG. 6) displayed on the operation terminal 1, the display processing portion 272 divides the display area and displays the setting screen P1 and the operation manual screen P2 side by side (two-screen display). Thus, the user is able to operate the setting screen P1 while looking at the operation manual screen P2, for example.

In the present embodiment, the control processing portion 273 further executes a display control process for linking the display content of the setting screen P1 and the operation manual screen P2.

More specifically, the reception processing portion 271 receives user operations on each the setting screen P1 and the operation manual screen P2. When the reception processing portion 271 receives a user operation on one of the setting screen P1 and the operation manual screen P2, the control processing portion 273 changes the display content of the other screen to the content corresponding to the user operation.

For example, when the reception processing portion 271 receives a user operation to select a predetermined setting item on the setting screen P1 of the operation terminal 1, the control processing portion 273 searches for a page related to the setting item in the operation manual, and displays the searched page in the right area D2. For example, as shown in FIG. 8, in a case where the user selects the “sheet selection” item on the setting screen P1 displayed in the left area D1 on the operation display portion 13 of the operation terminal 1, the control processing portion 273 searches the operation manual for a page related to “sheet selection” (here, page P3), and displays the searched page P3 in the right area D2. The control processing portion 273 sets, for example, an item selected by the user as a search keyword, and executes a search process of searching a plurality of pages included in the operation manual based on the search keyword.

Here, the control processing portion 273 may execute a search process according to the operation content of the user operation for a predetermined setting item, and display the search results in the divided area. More specifically, the control processing portion 273 executes different display processes depending on the length of time the user presses (touch operation, or the like) a setting item on the setting screen P1.

For example, in a case where the user presses a setting item on the setting screen P1 for less than a predetermined time (short press operation), the control processing portion 273 displays only a page in the operation manual that is most relevant to the setting item in the right area D2. For example, in a case where the user touches and immediately releases a predetermined setting item on the setting screen P1 (see FIG. 8), the control processing portion 273 determines that the operation is a short press operation and searches for a page that includes the most keywords for the setting item, and displays the page in the right area D2.

In addition, in a case, for example, where the user presses a setting item on the setting screen P1 for longer than the predetermined time (long press operation), the control processing portion 273 displays a list of pages in the operation manual that include the setting item as a keyword in the right area D2. For example, in a case where a predetermined time elapses while the user touches a predetermined setting item on the setting screen P1 (see FIG. 8), the control processing portion 273 determines that the operation is a long press operation, searches for all pages that include the keyword of the setting item, and displays a list of the pages in the right area D2.

Moreover, in a case, for example, where the user presses a setting item on the setting screen P1 for a time longer than an upper limit (excessive long press operation), the control processing portion 273 stops the search process of searching the operation manual. For example, in a case where the user touches a predetermined setting item on the setting screen P1 (see FIG. 8) and does not release it within the predetermined time period (in a case where the upper limit time elapses while the user continues to touch the setting item), the control processing portion 273 determines that the operation is an erroneous operation and does not perform the search process. In this case, the control processing portion 273 displays error information without changing the display content in the right area D2.

Furthermore, the control processing portion 273 may cause the operation display portion 13 to display information that allows identification of the time period during which a predetermined setting item is pressed. For example, when the control processing portion 273 determines that a predetermined setting item has been pressed on the setting screen P1 for a predetermined time or more (long press operation), the control processing portion 273 displays a time bar E1 (FIG. 8) on the setting screen P1. The control processing portion 273 may also perform the above-described search process based on the position of the elapsed time on the time bar E1. Note that the control processing portion 273 may display a pie chart or count up the elapsed time instead of the time bar E1. In addition, the control processing portion 273 may display the content of the search process according to the elapsed time in an identifiable manner on the time bar E1. Thus, the user is able to know the elapsed time, and thus the user can execute the intended search process.

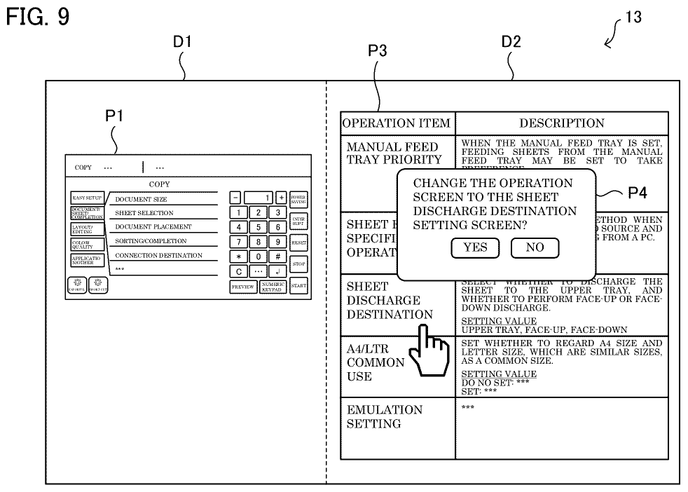

Moreover, the control processing portion 273 may also change the display content of the left area D1 based on a user operation on the operation manual screen P2. More specifically, in a case where the reception processing portion 271 receives a user operation to select a predetermined keyword included in the operation manual in the right area D2, the control processing portion 273 displays a selection screen P4 (see FIG. 9) for selecting whether or not to change the page currently displayed in the left area D1 to the page corresponding to the keyword, and in a case where an operation to change to a page corresponding to the keyword is received, the control processing portion 273 causes a change to the page corresponding to the keyword. For example, when the user selects the keyword “sheet discharge destination” on the operation manual screen P2 shown in FIG. 9, the control processing portion 273 displays the selection screen P4. When the user selects “YES” on the selection screen P4, the control processing portion 273 changes the display content in the left area D1 to a setting screen for setting the sheet discharge destination.

As described above, the control processing portion 273 causes the display content of the setting screen P1 and the operation manual screen P2 to be linked to each other based on the user's operations on each the setting screen P1 and the operation manual screen P2. Note that the control processing portion 273 may cause the display content of both the setting screen P1 and the operation manual screen P2 to be linked to each other on the operation display portion 21 of the image forming apparatus 2 based on user operations on each of the screens.

In addition, the control portion 27 performs overall control of the image forming apparatus 2 by controlling each portion such as the ADF 22, the image reading portion 23, and the image forming portion 24.

### [Operation Terminal 1]

As shown in FIG. 2, the operation terminal 1 includes a control portion 11, a storage portion 12, an operation display portion 13, a communication I/F 14, and the like. The operation terminal 1 is an operation device owned by a user who uses the image forming apparatus 2, and is, for example, an information processing device such as a notebook computer, a mobile terminal, or a smartphone.

The communication I/F 14 is a communication interface that connects the operation terminal 1 to the network N1 by wire or wirelessly, and executes data communication with external devices such as the image forming apparatus 2 via the network N1 according to a predetermined communication protocol.

The operation display portion 13 is a user interface that includes a display portion such as a liquid crystal display or an organic EL display that displays various types of information, and an operation portion such as a mouse, keyboard, or touch panel that receives operations. The operation display portion 13 displays a setting screen P1 (see FIG. 5, etc.) that receives setting operations for the image forming apparatus 2 from the user, an operation manual screen P2 (see FIG. 6, etc.) that displays an operation manual for the image forming apparatus 2, and the like. In addition, the operation display portion 13 displays the setting screen P1 and the operation manual screen P2 side by side in one display area (two-screen display) (see FIG. 7, etc.). The operation display portion 13 includes, for example, a touch panel, and receives touch operations from the user.

The storage portion 12 is a non-volatile storage portion such as a flash memory, a hard disk, or an EEPROM (registered trademark). For example, the storage portion 12 stores a control program such as a browser program. More specifically, the browser program is a control program for causing the control portion 11 to execute a communication process with an external device such as the image forming apparatus 2 according to a communication protocol such as HTTP (Hypertext Transfer Protocol).

The control portion 11 includes control devices such as a CPU, ROM, and RAM. The CPU is a processor that executes various types of arithmetic processing. The ROM is a non-volatile storage portion in which control programs such as a BIOS and an OS for causing the CPU to execute various types of processes are stored in advance. The RAM is a volatile or non-volatile storage portion that stores various types of information, and is used as a temporary storage memory (work area) for various types of processes executed by the CPU. The control portion 11, by the CPU, controls the operation terminal 1 by executing various types of control programs stored in the ROM or the storage portion 12 in advance.

More specifically, the control portion 11 functions as a browser processing portion 111 by executing various types of processes according to the browser program stored in the storage portion 12. The browser processing portion 111 is able to execute a browser process that causes the operation display portion 13 to display various types of information (setting screen P1, operation manual screen P2, etc.) provided from the image forming apparatus 2 (or server) via the network N1, and inputs an operation performed on the operation display portion 13 to the image forming apparatus 2. That is, the operation terminal 1 is able to function as an operation terminal for the image forming apparatus 2 by executing the browser program by the control portion 11. Note that a part or all of the processing portions included in the control portion 11 may be composed of electronic circuits.

### [Display Control Process]

Next, an example of a procedure of a display control process executed by the control portion 27 of the image forming apparatus 2 will be described with reference to FIG. 10. Here, steps S1, S2, and so on represent the numbers of processing procedures (steps) executed by the control portion 27. Note that the display control process is started when login information is transmitted from the operation terminal 1, and the display control process for the operation terminal 1 is executed. In addition, the present disclosure can be regarded as a disclosure of a display control method (corresponding to an information processing method according to the present disclosure) that executes one or more steps included in the display control process.

Moreover, one or more steps included in the display control process described here may be omitted as appropriate. Each step in the display control process may also be executed in a different order as long as similar effects are produced. Furthermore, a case where the control portion 11 executes each step in the display control process will be described as an example; however, in other embodiments, one processor may execute the steps of the display control process, or a plurality of processors may perform the steps of the display control process in a distributed manner.

First, in step S1, the control portion 27 determines whether or not an instruction to display the setting screen P1 has been received from the user via the operation terminal 1. For example, when a user issues a display instruction to display the setting screen P1 for operating the image forming apparatus 2 on the operation terminal 1, the control portion 27 receives the display instruction. When the control portion 27 receives the display instruction to display the setting screen P1 (S1: YES), the control portion 27 moves the process to step S2. On the other hand, in a case where the control portion 27 does not receive a display instruction to display the setting screen P1 (S1: NO), the control portion 27 shifts the process to step S3.

In step S2, the control portion 27 displays the setting screen P1 on the operation display portion 13 of the operation terminal 1 (see FIG. 5). Thus, the user can remotely operate the image forming apparatus 2 by operating the setting screen P1 on the operation terminal 1, such as causing the image forming apparatus 2 to execute a job. Step S2 is an example of a display step according to the present disclosure.

Next, in step S3, the control portion 27 determines whether or not a display instruction to display the operation manual screen P2 has been received from the user via the operation terminal 1. For example, when a user issues a display instruction to display the operation manual screen P2 on the operation terminal 1, the control portion 27 receives the display instruction. When the control portion 27 receives the display instruction to display the operation manual screen P2 (S3: YES), the control portion 27 moves the process to step S4. On the other hand, in a case where the control portion 27 does not receive the display instruction to display the operation manual screen P2 (S3: NO), the control portion 27 ends the display control process.

In step S4, the control portion 27 causes the operation manual screen P2 to be displayed on the operation display portion 13 of the operation terminal 1 (see FIG. 6). Thus, the user can check the operation manual of the image forming apparatus 2 on the operation terminal 1. Step S4 is an example of a display step according to the present disclosure.

Next, in step S5, the control portion 27 determines whether a display instruction for two-screen display has been received from the user via the operation terminal 1. For example, when a user issues a display instruction for two-screen display on the operation terminal 1, the control portion 27 receives the display instruction. When the control portion 27 receives the display instruction for two-screen display (S5: YES), the control portion 27 moves the process to step S6. On the other hand, in a case where the control portion 27 does not receive the display instruction for two-screen display (S5: NO), the control portion 27 ends the display control process.

In step S6, the control portion 27 divides one display area on the operation display portion 13 of the operation terminal 1 into two divided areas, and displays a screen in each divided area (two-screen display). For example, as shown in FIG. 7, the control portion 27 divides one display area into a left area D1 and a right area D2, displays a setting screen P1 in the left area D1, and displays an operation manual screen P2 in the right area D2. Note that the user may be able to select the screen to be displayed in each divided area on the operation display portion 13. That is, in the present disclosure, the content of the screens collectively displayed in one display area of the operation terminal 1 are not limited to the setting screen P1 and the operation manual screen P2. Step S6 is an example of a display step according to the present disclosure.

Next, in step S7, the control portion 27 determines whether a search operation has been received from the user via the operation terminal 1. More specifically, the control portion 27 receives a search operation from the user on the setting screen P1 and the operation manual screen P2 (see FIG. 7) displayed on the operation display portion 13 of the operation terminal 1. Search operations include operations on each of the setting screen P1 and the operation manual screen P2 such as touching a predetermined item (keyword) for a short time (short press operation), and an operation of touching a predetermined item (keyword) continuously for a long time (long press operation), and the like. When the control portion 27 receives the search operation from the user (S7: YES), the control portion 27 moves the process to step S8. In a case where the control portion 27 does not receive the search operation from the user (S7: NO), the control portion 27 ends the display control process. Step S7 is an example of a reception step according to the present disclosure.

In step S8, the control portion 27 executes a search process according to the search operation and outputs a search result.

For example, in a case where the user touches a predetermined setting item on the setting screen P1 (see FIG. 7) and releases it immediately, that is, in a case where the setting item is held down for less than a predetermined time (short press operation), the control portion 27 extracts the page containing the most keywords for the setting item from the operation manual, and displays the page in the right area D2 (see FIG. 8).

In addition, for example, when the user presses a predetermined setting item continuously for a predetermined time or more (long press operation) on the setting screen P1 (see FIG. 7), the control portion 27 extracts all pages from the operation manual including the setting item as a keyword, and displays a list of the pages in the right area D2.

Moreover, for example, in a case where the user presses a predetermined setting item on the setting screen P1 (see FIG. 7) for more than an upper limit time (in a case where the upper limit time elapses while the user continues to touch the setting item), the control portion 27 determines that the operation has been erroneous and does not execute the search process. In this case, the control portion 27 displays the error information without changing the display content in the right area D2.

Further, for example, in a case where the user presses a predetermined keyword on the operation manual screen P2 (see FIG. 7), the control portion 27 extracts a page of setting items that matches the keyword from the setting screen P1, and displays the page in the left area D1. Note that, in a case where a keyword is selected by the user on the operation manual screen P2, the control portion 27 may display a selection screen P4 (see FIG. 9) in the left area D1 for selecting whether or not to change the page currently displayed to the page corresponding to the keyword. In this case, when the control portion 27 receives an operation (“YES”) from the user to change to the page corresponding to the keyword, the control portion 27 causes the page to change to the page corresponding to the keyword. Step S8 is an example of a control step according to the present disclosure.

The control portion 27 repeatedly executes the above-described process based on a user operation on the operation terminal 1.

As described above, the information processing system 10 according to the present embodiment displays a first screen (setting screen P1) that receives remote operation of the image forming apparatus 2, and a second screen (operation manual screen) related to the operation of the image forming apparatus 2 in one display area of the operation terminal 1, and is able to receive user operations on each of the first screen and the second screen. In addition, in a case where the information processing system 10 receives a user operation on one of the first screen and the second screen, the information processing system 10 changes the display content of the other screen to the content corresponding to the user operation.

With the configuration described above, for example, in a case where the user sets a setting item on the setting screen P1 on the operation terminal 1, an operation manual related to the setting item can be displayed next to the setting screen P1 (see FIG. 8). In this way, the setting screen P1 and the operation manual screen P2 are displayed in conjunction with each other, and thus the user can easily perform setting operations for the image forming apparatus 2. Therefore, it is possible to display a plurality of screens related to the operation of the image forming apparatus 2 in one display area of the operation terminal 1, and to improve the convenience of operations on the plurality of screens.

The technique according to the present disclosure may include the following configurations.

(1) The information processing system 10 is a system that can simultaneously display on one screen a remote panel connection screen (setting screen P1) that allows remote operation of a screen operation device (for example, image forming apparatus 2) and an operation manual related to the image forming apparatus 2 (operation manual screen P2), and is a system that makes it possible to control items on the operation manual based on operations and information on the remote panel connection screen. In addition, the image forming apparatus 2 is able to control operations on the remote panel connection screen based on operations on the operation manual.

(2) The information processing system 10 is also able to link the remote panel connection screen that allows remote operation of the image forming apparatus 2 and the operation manual screen. The information processing system 10 has a function of automatically executing a keyword search of the operation manual when a keyword area on the remote panel connection screen is pressed for a long time.

(3) In the information processing system 10, a level may be provided for a period from when it is determined that a keyword has been pressed for a long time until the long press is released. For example, when the long press is released within a short period of time after the operation is determined to be a long press, only the page of the operation manual with the most relevant keyword will be automatically displayed, when the long press is released within a short to long period after the operation is determined to be a long press, a list of search results will be displayed on the operation manual, and when the long press is not released within a long period of time after the operation is determined to be a long press, the operation will be regarded as an erroneous operation and the operation manual will not be searched.

(4) The information processing system 10 may also include a function of determining a level of long-pressing of a keyword. For example, when a short period of time passes after a keyword is determined to have been pressed for a long time, a bar (time bar E1) or a pie chart that clearly shows the long press time is displayed on the screen and indicates what kind of search is performed depending on the area in which the long press is released.

(5) The information processing system 10 also displays a dialog (selection screen P4) asking whether to change the screen when a keyword on the operation manual is pressed a long time, and automatically changes to a screen related to the keyword on the remote panel connection screen only when the change is selected.

The information processing system according to the present disclosure may include an image forming apparatus 2 and an operation terminal 1 (user terminal), may include the image forming apparatus 2 alone, or may include a server device (not shown) alone. For example, the server device may include the reception processing portion 271, the display processing portion 272, and the control processing portion 273 of the image forming apparatus 2, and may execute each of the processes described above. That is, the server device may execute the display control process (see FIG. 10).

### [Supplementary Notes]

Hereinafter, a summary of the disclosure extracted from the above-described embodiments will be added. Note that each configuration and each processing function described in the following supplementary notes may be selected and combined as desired.

### <Supplementary Note 1>

An information processing system, includes:
a display processing portion configured to display a first screen for receiving a remote operation of an image forming apparatus and a second screen for operating the image forming apparatus in one display area of an operation terminal;
a reception processing portion capable of receiving user operations on each of the first screen and the second screen; and
a control processing portion configured to change display content on one screen of the first screen and the second screen to content corresponding to the user operation when the reception processing portion receives the user operation on the other screen.

### <Supplementary Note 2>

The information processing system according to supplementary note 1, wherein
the first screen displayed in a first area of the display area is a setting screen that receives setting operations for setting the image forming apparatus;
the second screen displayed in the second area of the display area is an operation manual screen that displays an operation manual for the image forming apparatus; and
in a case where the reception processing portion receives a user operation to select a predetermined setting item on the first screen, the control processing portion searches for a page related to the setting item in the operation manual, and displays the searched page in the second area.

### <Supplementary Note 3>

The information processing system according to supplementary note 1 or supplementary note 2, wherein
the control processing portion executes a search process according to operation content of a user operation on the predetermined setting item, and displays search results in the second area.

### <Supplementary Note 4>

The information processing system according to any one of supplementary notes 1 to 3, wherein
the control processing portion,
in a case where the predetermined setting item is pressed for less than a predetermined time, displays only a page most relevant to the predetermined setting item in the operation manual in the second area;
in a case where the predetermined setting item is pressed for the predetermined time or more, a list of pages of the operation manual including the predetermined setting item as a keyword is displayed in the second area; and
in a case where the predetermined setting item is pressed for a time longer than an upper limit, stops a search process of the operation manual.

### <Supplementary Note 5>

The information processing system according to any one of supplementary notes 1 to 4, wherein
the control processing portion causes the display area to display information capable of identifying a time during which the predetermined setting item is pressed.

### <Supplementary Note 6>

The information processing system according to any one of supplementary notes 1 to 5, wherein
in a case where the reception processing portion receives a user operation to select a predetermined keyword included in the operation manual in the second screen, the control processing portion displays a selection screen for selecting whether or not to change a page currently displayed in the first screen to a page corresponding to the keyword, and in a case where an operation to change to a page corresponding to the keyword is received, the control processing portion causes a change to the page corresponding to the keyword.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing system, comprising:
a display processing portion configured to display a first screen for receiving a remote operation of an image forming apparatus and a second screen for operating the image forming apparatus in one display area of an operation terminal;
a reception processing portion capable of receiving user operations on each of the first screen and the second screen; and
a control processing portion configured to change display content on one screen of the first screen and the second screen to content corresponding to the user operation when the reception processing portion receives the user operation on the other screen.

2. The information processing system according to claim 1, wherein
the first screen displayed in a first area of the display area is a setting screen that receives setting operations for setting the image forming apparatus;
the second screen displayed in the second area of the display area is an operation manual screen that displays an operation manual for the image forming apparatus; and
in a case where the reception processing portion receives a user operation to select a predetermined setting item on the first screen, the control processing portion searches for a page related to the setting item in the operation manual, and displays the searched page in the second area.

3. The information processing system according to claim 2, wherein
the control processing portion executes a search process according to operation content of a user operation on the predetermined setting item, and displays search results in the second area.

4. The information processing system according to claim 3, wherein
the control processing portion,
in a case where the predetermined setting item is pressed for less than a predetermined time, displays only a page most relevant to the predetermined setting item in the operation manual in the second area;
in a case where the predetermined setting item is pressed for the predetermined time or more, a list of pages of the operation manual including the predetermined setting item as a keyword is displayed in the second area; and
in a case where the predetermined setting item is pressed for a time longer than an upper limit, stops a search process of the operation manual.

5. The information processing system according to claim 4, wherein
the control processing portion causes the display area to display information capable of identifying a time during which the predetermined setting item is pressed.

6. The information processing system according to claim 2, wherein
in a case where the reception processing portion receives a user operation to select a predetermined keyword included in the operation manual in the second screen, the control processing portion displays a selection screen for selecting whether or not to change a page currently displayed in the first screen to a page corresponding to the keyword, and in a case where an operation to change to a page corresponding to the keyword is received, the control processing portion causes a change to the page corresponding to the keyword.

7. An information processing method, comprising:
a display step of displaying a first screen for receiving a remote operation of an image forming apparatus and a second screen for operating the image forming apparatus in one display area of an operation terminal;
a reception step capable of receiving user operations on each of the first screen and the second screen; and
a control step of changing display content on one screen of the first screen and the second screen to content corresponding to the user operation when the user operation is received on the other screen.
